(19) United States
(12) Patent Application Publication
(10) Pub. No.: US 2006/0212930 A1
(43) Pub. Date: Sep. 21, 2006

(54) Distribution of trust data

(75) Inventors: Mark Shull, Chevy Chase, MD (US); William Bohlman, Boise, ID (US); Ihab Shraim, Germantown, MD (US); Christopher J. Bura, Pleasant Hill, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MarkMonitor, Inc., Boise, ID (US)

(21) Appl. No.: 11/368,255

(22) Filed: Mar. 2, 2006

Related U.S. Application Data
(60) Provisional application No. 60/658,124, filed on Mar. 2, 2005.
(60) Provisional application No. 60/658,087, filed on Mar. 2, 2005.
(60) Provisional application No. 60/658,281, filed on Mar. 2, 2005.

(51) Int. Cl. H04L 9/32

(52) U.S. Cl. 726/10

(57) ABSTRACT

Embodiments of the present invention provide methods, systems, software for providing, distributing and/or using trust scores for online entities. In accordance with various embodiments, one or more trust score servers may be configured to provide trust scores, perhaps in response to a request (e.g., from another trust scores server, from a client, from a border device, etc.). In other embodiments, a computer (e.g., a border device, a client, etc.) may maintain a local cache of trust scores. In some cases, a computer may request a trust score for a particular online entity in response to receiving, detecting and/or attempting to transmit a communication with that online entity.

### CROSS-REFERENCE TO RELATED APPLICATIONS

This application claims the benefit of the following provisional U.S. patent applications, of which the entire disclosure of each is incorporated herein by reference: provisional U.S. Pat. App. No. 60/658,124, entitled “Distribution of Trust Data,” and filed Mar. 2, 2005 by Shull et al.; provisional U.S. Pat. App. No. 60/658,087, entitled “Trust Evaluation Systems and Methods,” and filed Mar. 2, 2005 by Shull et al.; and provisional U.S. Pat. App. No. 60/658,281, entitled “Implementing Trust Policies,” and filed Mar. 2, 2005 by Shull et al.

This application is also related to the following applications, the entire disclosure of each of which is incorporated herein by reference: U.S. patent application Ser. No. 11/339,985, entitled “Online Identity Tracking,” and filed Jan. 25, 2006 by Shull et al.; U.S. Pat. App. No. ______, entitled “Trust Evaluation Systems and Methods,” and filed on a date even herewith by Shull et al. (attorney docket no. 040246-002410); and U.S. Pat. App. No. ______, entitled “Implementing Trust Policies,” and filed on a date even herewith by Shull et al. (attorney docket no. 040246-002610).

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

As ever more business is transacted online, the ability to evaluate online entities becomes increasingly important. For example, if a user desires to transact business online with a particular entity, the user generally would like to be able to determine with a high degree of confidence that the entity actually is who it purports to be, and that the entity is trustworthy, at least for the purposes of the transaction. Various solutions have been proposed to provide some verifiable identification of entities, including without limitation the Domain Keys system proposed by Yahoo, Inc., the Sender Profile Form (“SPF”) system, and the SenderID for Email scheme proposed by Microsoft, Inc. These systems all attempt to provide identity authentication, for example, by guaranteeing that an IP address or domain name attempting to transmit the email message, web page, or other data is the actual IP address or domain purporting to transmit the data, and not a spoofed IP address or domain name.

These solutions, however, fail to address a much larger issue. In many cases, the mere verification that a message originates from a particular domain provides little assurance of the character of the online entity. For certain well-known domains, such as <microsoft.com>, the domain name itself may provide a relatively reliable identification of the entity operating the domain, assuming no mistypings or unusual derivations containing some form of the name. For most domains and IP addresses, however, the domain name or source IP address cannot be considered, on its own, to provide reliable information on the trustworthiness of the underlying domain or IP address itself.

The well-known WHOIS protocol attempts to provide some identification of the entity owning a particular domain. Those skilled in the art will appreciate, however, that there is no authoritative or central WHOIS database that provides identification for every domain. Instead, various domain name registration entities (including without limitation registrars and registries) provide varying amounts of WHOIS registrant identity data, which means that there is no single, trusted or uniform source of domain name identity data. Moreover, many registrars and registries fail to follow any standard conventions for their WHOIS data structure, meaning that data from two different registrars or registries likely will be organized in different ways, making attempts to harmonize data from different databases difficult, to say the least. Further compounding the problem is that most WHOIS databases cannot be searched except by domain name, so that even if the owner of a given domain can be identified, it is difficult (if not impossible) to determine what other domains that owner owns, or even to determine whether the ownership information for a given domain is correct. Coupled with the reality that many domain owners provide mostly incorrect domain information, this renders the WHOIS protocol virtually useless as a tool for verifying the identity of a domain owner.

The concept of a “reverse WHOIS” process has been proposed as one solution to this issue. Reverse WHOIS, which provides more sophisticated data-collection and searching methods for WHOIS information, is described in further detail in the following commonly-owned, co-pending applications, each of which is hereby incorporated by reference, and which are referred to collectively herein as the “Reverse WHOIS Applications”: U.S. patent application Ser. Nos. 11/009,524, 11/009,529, 11/009,530, and 11/009,531 (all filed by Bura et al. on Dec. 10, 2004). The concept of reverse WHOIS addresses some of the problems in identifying the owner of a domain. However, as with the WHOIS protocol, the reverse WHOIS protocol does not provide any indication of the trustworthiness of an online entity. Moreover, WHOIS data generally is not use programmatically.

Consider, for example, a situation in which an online fraud has been identified. Systems for identifying and responding to online fraud are described in detail in the following commonly-owned, co-pending applications, each of which is hereby incorporated by reference, and which are referred to collectively herein as the “Anti-Fraud Applications”: U.S. patent application Ser. No. 10/709,938 (filed by Shraim et al. on May 2, 2004); U.S. patent application Ser. Nos. 10/996,566, 10/996,567, 10/996,568, 10/996,646, 10/996,990, 10/996,991, 10/996,993, and 10/997,626 (all filed by Shraim, Shull, et al. on Nov. 23, 2004); and U.S. patent application Ser. No. 11/237,642, filed by Shull et al. on Sep. 27, 2005. In many cases, an IP address of a server engaged in online fraud may be available. However, there are currently no mechanisms to notify other entities that the domain name and/or IP address was associated with an online fraud.

Thus, mechanisms are needed to evaluate and provide an indication of the trustworthiness of online entities, including without limitation domain names and IP addresses, as well as the users and/or owners of those domain names and IP addresses.

### BRIEF SUMMARY

Embodiments of the present invention provide methods, systems, software for creating, providing, distributing and/or using trust scores for online entities. In accordance with various embodiments, one or more trust score servers may be configured to provide trust scores, perhaps in response to a request (e.g., from another trust scores server, from a client, from a border device, etc.). In other embodiments, a computer (e.g., a border device, a client, etc.) may maintain a local cache of trust scores. In some cases, a computer may request a trust score for a particular online entity in response to receiving, detecting and/or attempting to transmit a communication with that online entity.

An exemplary method in accordance with one set of embodiments comprises detecting, at a computer (e.g., a border device, client computer, etc.), a communication associated with an online entity. Merely by way of example, the detected communication may be a request for data from the online entity, a communication received from the online entity, a communication addressed to the online entity, etc. A trust score associated with the online entity may then be obtained. Based on the trust score, the computer can determine an appropriate action to take with respect to the communication, and, in some cases, might take that action.

In some aspects, obtaining the trust score may comprise obtaining the trust score from a domain name system (DNS) record associated with the online entity. In other aspects, obtaining the trust score may comprise determining if a local trust cache includes the trust score. If the local trust cache does include the trust score, the trust score may be retrieved from the local trust cache. Otherwise, if the local trust cache does not include the trust score, obtaining the trust score may further comprise transmitting a request for the trust score from the computer to a trust score server. The trust score server may retrieve the trust score from a server cache associated with the trust score server and may transmit the trust score to the computer. Alternatively, if the server cache does not include the trust score, the trust score server may transmit a request for the trust score to a second trust score server at a higher hierarchical level than the trust score server and may receive the trust score from the second trust score server. The trust score server may then store the trust score in the server cache.

In some aspects, the method may further comprise receiving a request for the trust score at a trust score server (which may be, for example, a root server, an authoritative server, a trust evaluation system, etc.). The trust server may retrieve the trust score from a trust data store and/or may transmit a trust score request to another trust score server. The retrieved trust score may then be transmitted to a lower hierarchy trust score server.

In a second set of embodiments, a method of distributing trust scores from a trust evaluation system comprises determining, at the trust evaluation system, a trust score for each of a plurality of online entities. The trust evaluation system and/or policy engine populates a (perhaps local) trust database with the trust scores. At least a portion of the data included in the trust database may be transmitted to a cache server (e.g., a root or authoritative trust server, an intermediate cache server, etc.). The method may also further include transmitting at least a second portion of the data included in the data store to one or more additional cache servers.

In another set of embodiments, a method of distributing trust scores from a trust evaluation system comprises retrieving a first plurality of trust scores from a trust data store (such as a trust database, for example). The first plurality of trust scores may be associated with a first set of online entities (which may correspond to a first online region, such as, merely by way of example, to geographical region, a top level domain, etc.). Each of the first plurality of trust scores evaluates an online entity included in the first first set A second plurality of trust scores are also retrieved from the trust data store. The second plurality of trust scores are associated with a second set of online entities (which may, in turn, correspond to a second online region), and each of the second plurality of trust scores evaluates an online entity included in the second set. The first plurality of trust scores are transmitted to a first trust score server and the second plurality of trust scores are transmitted to a second trust score server.

In yet another set of embodiments, a method for distributing trust scores comprises maintaining, at a domain name system (DNS) server, a DNS record comprising a set of information about an online entity, the set of information comprising one or more trust scores associated with the online entity. Upon request, at least some of the set of information about the online entity may be provided. The request may be a DNS lookup request, a request for a trust score, etc.

Other embodiments provide methods of providing trust scores. An exemplary method comprises providing a database (which may comprise one or more trust scores for each of a plurality of online entities; each of the trust scores may indicate an evaluation of the trustworthiness of an online entity to which the trust score relates), receiving at a computer a request for at least one of the one or more trust scores of one of the plurality of entities, and/or providing with the computer, in response to the request, the at least one of the one or more trust scores.

Another set of embodiments provides systems, including without limitation systems configured to implement methods of the invention. An exemplary trust authentication system, for example may comprise a client application configured to communicate with online entities and a monitoring agent communicatively coupled with the client application. The monitoring agent obtains trust scores for the online entities.

The trust authentication system may, in some aspects, further comprise a local trust cache, which may be configured to cache a plurality of the trust scores. The local trust cache may be (but need not be) a DNS cache (which might be a host file, etc.) and/or may be mapped to DNS and/or IP address records. The monitoring agent may also be configured to request from a trust score server any trust scores not included in the local trust cache. In other aspects, the trust authentication system may further comprise a trust evaluation system to evaluate online entities. The trust evaluation system may be configured to create the trust scores for the online entities.

Other embodiments provide systems for providing trust scores. An exemplary system may comprise at least one database. The database(s) may comprise for each of a plurality of online entities, and/or each of the trust scores may indicate an evaluation of the trustworthiness of an online entity to which the trust score relates. The system may further comprise at least one trust server in communicating with the at least one database. The trust server may comprise a processor and/or instructions executable by a processor to receive a request for at least one of the one or more trust scores for one of the plurality of entities; and/or to provide, perhaps in response to a request, at least one of the one or more trust scores.

In accordance with some embodiments, the at least one database is a plurality of databases, and/or the at least one trust server is a plurality of trust servers, each of which may be in communication with one or more of a plurality of databases. The plurality of databases may comprise a first database having a first subset of a set of trust scores and/or a second database having a second subset of a set of trust scores. The plurality of trust servers, then, may comprise a first trust server in communication with the first database and a second trust server in communication with the second database. The first trust server may be designated as an authoritative server with respect to the first subset of the set of trust scores, and/or the second server may be designated as an authoritative server with respect to the second subset of the set of trust scores.

The first subset may comprise trust scores for a first plurality of online entities, and/or the second subset may comprise trust scores for a second plurality of online entities. The first plurality of online entities may be located in a first region and/or may be associated with domains in a first top level domain, while the second plurality of online entities may be located in a second region and/or may be associated with domains in a second top level domain. Alternatively and/or in addition, the first subset of the set of trust scores may comprise trust scores related to a first category of activity, and/or the second subset of the set of trust scores may comprise trust scores related to a second category of activity. In other embodiments, the first subset of the set of trust scores comprises trust scores scaled according to a first scale, and/or the second subset of the set of trust scores comprises trust scores scaled according to a second scale. One or more of these scales may comprise a blacklist, whitelist, one or more greylists, etc.

Some embodiments may further comprise a root server, which may have a processor and/or instructions executable by a processor to receive a request for a trust score, determine whether the requested trust score falls within the first subset of the set trust scores or the second subset of trust scores, and/or provide a reference to either the first trust server or the second trust server, perhaps depending on which subset of the set of trust scores the requested score falls within.

A further set of embodiments provides software programs, including without limitation software programs implementing methods of the invention. An exemplary program, which may be embodied on at least one computer readable medium, may comprise instructions executable by one or more computers to maintain a database (which may comprise one or more trust scores for each of a plurality of online entities), receive a request for at least one of the one or more trust scores of one of the plurality of entities, and/or provide, in response to the request, the at least one of the one or more trust scores.

A further understanding of the nature and advantages of the present invention may be realized by reference to the remaining portions of the specification and the drawings.

### BRIEF DESCRIPTION OF THE DRAWINGS

FIG. 1 illustrates exemplary sources of data that may be used by a trust evaluation system to determine the trustworthiness of online entities.

FIG. 2 illustrates an exemplary block diagram of a system that may be used to provide trust data about online entities.

FIG. 3 is a block diagram of a computer system upon which a trust evaluation system may be implemented.

FIG. 4 is a flow diagram illustrating an exemplary method that may be used to evaluate the trustworthiness of an online entity.

FIG. 5 illustrates a system that may be used to distribute trust data according to various embodiments.

FIG. 6 illustrates a system that may be used to distribute trust data in accordance with various embodiments.

FIG. 7 illustrates an exemplary system that may be used to apply trust polices to communications.

FIG. 8 is a flow diagram illustrating an exemplary method that may be used to acquire trust data.

FIG. 9 is a flow diagram illustrating an exemplary method that may be used to implement trust policies.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

Various embodiments of the invention provide the ability to calculate a trust score for an online entity based on the online entity's identification, relationships, history, and/or other information. Merely by way of example, data sets which may be acquired and used to evaluate an entity's trustworthiness may include, without limitation, WHOIS data, network registration data, UDRP data, DNS record data, hostname data, zone file data, fraud-related data, corporate records data, trademark registration data, hosting provider data, ISP and online provider acceptable use policy (“AUP”) data, past security event data, case law data, and/or other primary and/or derived data related to the registration, background, enabling services, and history of an entity on the Internet. The information used to evaluate an online entity may be gathered and correlated as described in U.S. patent application Ser. No. 11/339,985, already incorporated by reference, as well as provisional U.S. Pat. App. No. 60/647109, filed Jan. 25, 2005, entitled “Online Identity Tracking,” the entire disclosure of which is hereby incorporated by reference. (Together, these two applications are referred to herein as the “Online Identity Tracking Application.”)

The trust scores may be provided to third parties (such as users, administrators, ISPs, etc.) to allow those third parties to make determinations about the trustworthiness of an online entity. Based on such determinations, the third parties may choose to take specific actions with respect to communications and/or data received from the entity. In one set of embodiments, a structure similar to a DNS system, with caching servers, root servers (and/or core servers), and/or authoritative servers, may be provided to allow third parties to obtain trust scoring information about a particular entity.

An online entity may be a person and/or business (such as the owner of a domain, the operator of a server, etc.), a domain name, a hostname, an IP address (and/or network block), a computer (such as a server) and/or any other person or thing that maintains an online presence and therefore is capable of being identified. Particular embodiments, therefore, may calculate trust scores based on information stored in one or more databases (which may be global and/or searchable) that can be used to provide records, experience and/or other information about the ownership, relationship, historical, and/or behavioral attributes of entities on the Internet, including domain names, IP addresses, registrars, registries and ISPs. These databases may be used to determine associations between online entities and illicit activities, including without limitation phishing scams, trademark infringement, fraudulent sales and/or solicitations, misappropriation of identities and/or brand names, unwanted spam and/or pop-up windows, viruses, malicious code, spyware, trojans, and/or other security threats, and/or other illegitimate activities. In accordance with some embodiments, trust scores may be used to predict the trustworthiness of an online entity.

Particular embodiments further provide the ability for trust database(s) (also referred to herein and in the Online Identity Tracking Application as reputation databases and/or reputational databases) to interact functionally and/or to be used in conjunction with other authentication schemes, including without limitation DNS-based schemes, such as SPF, Domain Keys, etc., to provide authentication of the domain name and/or IP address as well as providing a score to inform a user, administrator and/or application of the trustworthiness of the entity associated with the domain name or IP address. The identifying information and/or aggregate history of the domain name and/or IP address may also be analyzed and/or assigned a probability score indicating the probability that the entity is trustworthy. As used in this context, the term “trustworthy” means that the entity is engaged in legitimate online activity, as opposed to unsafe, dangerous, unwanted and/or otherwise illegitimate activities (which can include a variety of online activities, such as phishing and/or other types of fraud and/or abuse, cybersquatting, legal and/or illegal pornography, transmitting spam, pop-up messages and/or any other types of unwanted communications, viruses, malicious code, spyware, trojans, and/or other security threats). In accordance with various embodiments and implementations, any of a variety of questionable activities may be considered illegitimate and therefore might render an entity performing such activities as untrustworthy. The term “reputation” is sometimes used herein to indicate an entity's reputation (as determined by embodiments of the invention) as being relatively trustworthy or untrustworthy.

It should be noted that, while existing anti-spam systems purport to implement “reputation databases,” those databases merely track the senders of spam and allow for the compilation of complaints from users about those senders. Embodiments of the current invention provide a much more robust framework for evaluating the trustworthiness (perhaps across a variety of characteristics and/or categories of activity) of any particular entity, rather than merely tracking purveyors of spam.

In an aspect of the invention, some embodiments can be considered to associate or bind a trust score to an authenticated source name (which could be a domain name, personal name, corporate name, IP address, etc.). If the source name is authenticated (using, for example, a standard authentication scheme, such as SPF, SenderID for Email, DomainKeys, etc., and/or authentication by the trust provider or a third party, using, for example, an identity tracking system and/or the like), the trust score is likely to be relatively more reliable and/or valuable, since the combination of authentication and trust score ensures that a user knows first that an entity is who that entity purports to be and second that the entity is trustworthy. Nonetheless, trust scores may also be provided for unauthenticated entities (and, as described herein, the fact that an entity has not been authenticated may be a factor to be considered in determining the trust score). In some embodiments, neither the sender of the communication nor the recipient need know either other (or even actively participate in the trust evaluation process) in order for trust evaluation services to be provided.

Such a score might be made available to users (and/or others, such as administrators and/or applications) via a secure and/or authenticated communication. The score might be matched with a domain name and/or IP address authenticated via one of the authentication schemes mentioned above and/or any encryption, authentication, non-repudiation and/or other security schemes. The user (or other) would be able to see and/or use the score, which may be provided by an authoritative server (such as a trust evaluation system, described below), one or more root and/or caching servers (which may include copies of one or more score databases, as described below, and/or pointers to an authoritative source for scores), and/or the like. In a particular set of embodiments, score information may be provided by enhancements to the current domain name system (“DNS”) and/or various certification systems and/or by a hierarchical system with a structure similar to the DNS, and use the transmitted data accordingly.

In a set of embodiments, the trust score indicates the overall trustworthiness of the entity and/or the likelihood that the entity is a source of fraud, abuse, unwanted traffic and/or content (such as spam, unwanted pop-up windows, etc.), viruses, etc. and/or the entity's trustworthiness in general and/or for specific situations, such as commercial transactions, etc. Trust score(s) can also be used as input to inform a broader policy manager (which might operate on an ISP-wide and/or enterprise-wide level, and/or at the individual computer, operating system, application and/or user level for example), which dictates how specific traffic should be handled, based on the score of an online entity originating that traffic and/or the score of the intended recipient of the traffic. Merely by way of example, based on the score associated with a given communication (such as an email message, HTTP transmission, etc.), that communication might be allowed, blocked, quarantined, tracked, and/or recorded (e.g., for further analysis), and/or a user and/or administrator might be warned about the communication. Other security and/or business policies could be implemented as well. For instance, this exemplary model may provide a simple, and therefore fast way to handle communications with various entities. It may be used across multiple categories of trust scores, and/or it may be expanded, restricted and/or modified to accommodate other requirements, such as for a richer set of handling options. Various categories in which scores may be accorded different handling options might include any types of communications that a user might want to treat in various ways, including by way of example, pornography, spam, phishing attacks, etc. For instance, a given user might not mind receiving spam but might be very wary of phishing scams, so the user might configure a trust application to allow relatively free communications with entities having a relatively poor reputation with respect to sending spam but to be very restrictive on communications from (or to) entities with a reputation of being associated (even loosely) with phishing scams. Hence, polices can be tuned to account for types of traffic and/or to filter based on personal preferences.

Such policies may be implemented in a variety of ways. Merely by way of example, a border device (such as a firewall, proxy, router, etc.) that serves as a gateway to an enterprise, etc. may be configured to obtain a score for each incoming (and/or outgoing) communication, and based on that score, take an appropriate action (such as one of the actions described above). As another example, client software on a user's computer may be configured to obtain a score for each communication and act accordingly. For instance, a web browser, application and/or operating system might be configured (via native configuration options and/or via a toolbar, plug-in, extension, etc.) to obtain a score (e.g., from a server, etc.) for each web page downloaded (and/or, more specifically, for the entity transmitting the web page). If that score, for instance, indicated that the web page was likely to be a phishing attempt or evidence other risky or unwanted characteristics, the browser could warn the user of that fact and/or could refused to load the page (perhaps with a suitable warning to the user), and/or to take other appropriate action(s). Embodiments of the invention may be configured to provide multiple and/or parallel alert levels or types, depending on various scores accorded the entity associated with a given communication. Other embodiments might also provide active selection, quarantine, filtering and/or dropping of various communications.

An email client application might operate similarly with respect to email. For example, the email client may use one or more trust scores to determine a probability that an email contains a virus, is associated with a fraudulent activity, is associated with a phishing attempt, and/or is likely to be unwanted traffic (spam, pop-ups, pornography, etc.). Accordingly, based on the trust score(s), the email client may quarantine the message, block the message, warn the user, allow the message to pass or take other appropriate action.

Trust score(s) may be analogized roughly to a credit score. Based on a history (generally of multiple inputs and/or security events) and/or with other ascertained identification information, score(s) may be derived and/or used in real-time, near-real-time and/or asynchronous transaction processing. As with credit card scores, trust score(s) may change over time based on updated information. While various embodiments may provide a variety of evaluation information to users (and/or others), a simple scoring system (e.g., 1-5, as described elsewhere herein) allows the system to be both fast and extensible (since multiple scores, based on various characteristics and/or categories of behavior, such as spam, fraud, phishing, pornography, etc., may be accorded a single entity).

Thus, embodiments of the invention provide mechanisms to evaluate and provide indications of the trustworthiness (reputation) of, and/or predetermined interest in, online entitles.

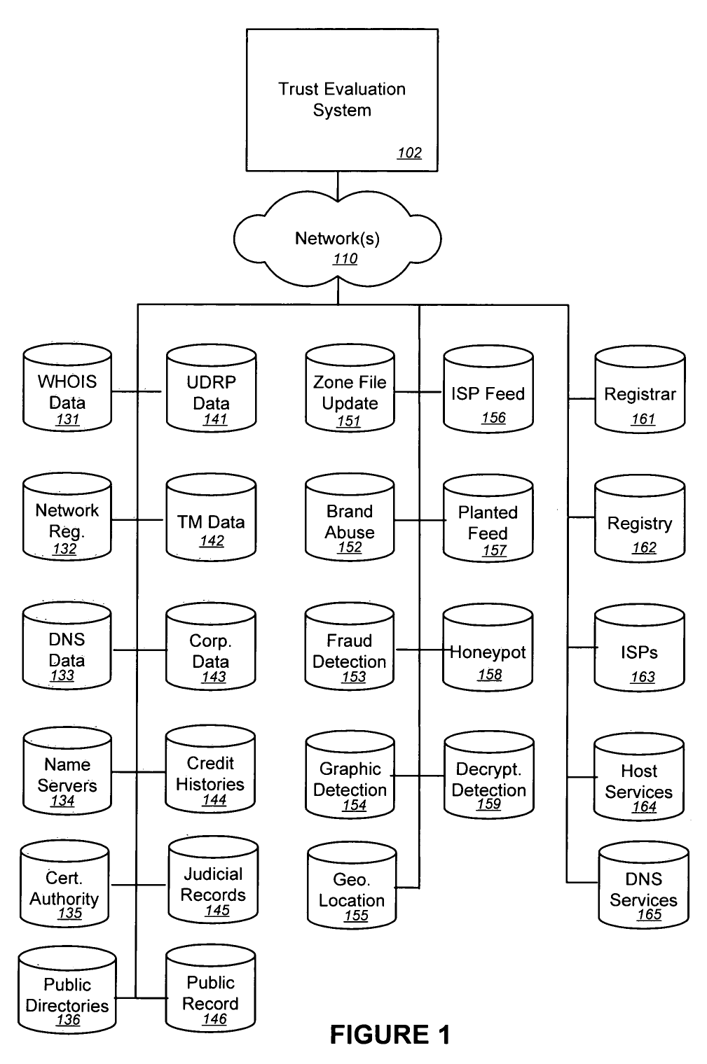

FIG. 1 illustrates exemplary sources of data that may be used by a trust evaluation system to determine the trust scores of online entities. Trust evaluation system 102 may comprise one or more computers (including, merely by way of example, personal computers, servers, minicomputers, mainframe computers, etc.) running one or more appropriate operating systems (such as any appropriate variety of Microsoft Windows; UNIX or UNIX-like operating systems, such as OpenBSD, Linux, etc.; mainframe operating systems, such as OS390, etc.), along with application software configured to perform methods and/or procedures in accordance with embodiments of the invention. In particular embodiments, trust evaluation system 102 may comprise, be incorporated in and/or operate in conjunction with any of the systems (and/or elements thereof) described in the Anti-Fraud Applications and/or the Online Identity Tracking Application.

Trust evaluation system 102 may be communicatively coupled with any number of different data sources 131-165 and/or other computers (not illustrated) via one or more networks 110. By way of example, network(s) 110 may include the Internet or other public area network(s) or private network(s). Other types of networks capable of supporting data communications between computers (such as cellular and/or wireless networks supporting Internet traffic between phones and other wireless devices) will also suffice.

Data sources 131-165 may contain information used by trust evaluation system 102 to evaluate and calculate trust score(s) for online entities. Various data sources, and methods and systems that may be used to gather and correlate data from data sources are described in further detail in the Online Identity Tracking Application. In some embodiments, the gathering and/or correlation of data from data sources 131-165 may be alternatively or additionally be performed by systems other than trust evaluation system 102. Thus, trust evaluation system 102 may obtain correlated data from one or more intermediary systems (not shown) interspersed between data source 131-165 and trust evaluation system 102.

Data sources used by trust evaluation system to evaluate and determine trust score(s) for online entities may include, without limitation, sources 131-136 of registration data, sources 141-146 of background data, sources 151-159 of harvested data, and/or sources 161-165 from and/or about enabling parties. The information from data sources 131-165 may be collected using any suitable operation designed to obtain data.

Registration data sources may include one or more WHOIS databases 131. Another type of registration data source may be network registration databases 132, such as databases maintained by ARIN, APNIC, LACNIC, RIPE and/or other entities responsible for allocating and/or maintaining records of IP addresses and/or networks. Other sources of registration data may include DNS data 133 (e.g., DNS databases or tables which may contain information related to DNS addressing of various hosts and/or networks), name servers 134, Internet root servers and/or systems that feed updates to root servers (not shown in FIG. 1), certificate authorities 135 (responsible for issuing and managing security credentials and/or public keys), or other public directory data sources 136. Data used by trust evaluation system 102 may also be obtained from other types of registration data sources.

Background data may be obtained from background data sources, such as data sources 141-146. UDRP data sources 141 may contain data related to UDRP complaints filed against online entities. Trademark data sources 142 may provide information relating to ownership of registered and/or unregistered trademarks. Corporate record data sources 143 may provide information related to the identities and/or ownership of various business entities, including but not limited to corporations. Other sources of background data may include credit history data 144, judicial records 145, other public record sources 146 (e.g., property records, telephone directories, voting records, tax records, etc.), and/or any other type of data source that may provide background information on an online entity.

Data may also be compiled and/or derived through monitoring, crawling, and/or anti-fraud operations. Exemplary harvesting operations are described in the Anti-Fraud Applications previously incorporated by reference, although any other harvesting technique may also be used to obtain the data. Merely by way of example, harvested data may include zone file updates 151 which can comprise comparisons or “diff” files of changes from one version of a zone file to the next. This may allow for the relatively expeditious ascertainment of new and/or modified domain registrations. Other exemplary sources of harvested data may include brand abuse data 152, fraud detection data 153 (which may include results of fraud detection/prevention operations and/or investigations), graphic detection data 154, geographical location data 155 (which may indicate geographical regions known to originate high percentages of fraudulent/illicit activities or other type of geographical information), ISP feeds 156 (which can comprise one or more email feeds of potential spam and/or phish messages), planted feed data 157 (feeds and/or results of planting operations), honeypots 158, and/or decrypted detection data 159 (detecting decryption operations). Further details and examples of ISP feeds 156, planted feeds 157 and honeypots 158 are described in the Anti-Fraud Applications previously incorporated by reference.

It should be appreciated that other types of harvested data may also be used by trust evaluation system 102 to determine reputations of online entities. Merely by way of example, U.S. patent application Ser. No. 11/237,642. already incorporated by references, describes systems that can be used to provide harvested data for determining reputations of online entities. Further sources of data can include feeds from search engines, security providers and/or ISPs, rating services (including whitelists, blacklists, etc.) and/or the like.

Data from and/or about enabling parties may also be used by trust evaluation system 102. An “enabling party,” as that term is used herein, can be any party that provides services facilitating an entity's presence on the Internet. Examples of enabling parties can include, without limitation, registrars 161 and/or registries 162, ISPs 163, hosting providers 164, DNS providers 165, and/or the like. Data about and/or from these parties can include data compiled and/or maintained by these providers about their customers, data about the providers themselves (including, merely by way of example, identifiers such as IP addresses, domains, network blocks, addresses, locations, legal jurisdictions, acceptable use policies, ICANN and/or other regulatory compliance policies and/or practices, data integrity, practices of promoting, selling to and/or shielding known participants in illegitimate activities, etc. that may identify a provider), trends and/or amenability of a given provider to facilitate illicit activity, historical behavior of customers of a given provider, etc.

As previously described, any suitable technique may be used to gather data from data sources 131-165. Once the data is gathered it may be cross-indexed and/or cross-referenced based on matching or similar information. Merely by way of example, if a harvested WHOIS record contains information for a particular domain, and a harvested DNS record provides name server information for a host in that particular domain, the information in the DNS record may be cross-indexed and/or cross-referenced against that WHOIS record. Data may also be grouped. If for instances, an identified individual owns other domains, information about those domains may be associated with each other and/or grouped with other cross-indexed information. Further details about data correlation may be found in the Online Identity Tracking Application previously incorporated by reference.

The correlation of data from a variety of data sources may provide predictive functionality. For example, if a particular individual is associated with a known phishing scam, any other IP addresses, domain names, etc. associated with that individual (through, for example, a cross-indexing operation), may be assumed to be relatively more likely to be involved in phishing scams as well (and/or, as described below, may be scored and/or added to a greylist as an associate of a known participant in illegitimate activity). Through these cross-indexing associations, trend information may be revealed as well. Merely by way of example, an analysis of associations may reveal that a particular ISP, domain name registry and/or name server is relatively more likely to be a provider for phishing operations. Other domains and/or IP addresses associated (again, through the cross-indexing procedures and/or through other procedures) with that provider may then be relatively more likely to be involved in illicit activities. Hence, it may be appropriate to block a set of domains and/or a range of IP addresses, if the data reveals a pattern of abuse relating to parties associated with such domains and/or addresses.

In this way, trust evaluation system 102 may use correlated data gathered from data sources, such as data sources 131-165, to develop a trust database. For any online entity, for example, an analysis of some or all cross-indexed and/or associated data may allow a relatively confident determination of whether that individual, who may attempt to deceive a user (or another), is in fact involved in illicit and/or unwanted online activity. Merely by way of example, if a domain owner uses the services of a registry and/or ISP known to be friendly to phishers, pornographers, etc., it may be relatively more likely that a web site hosted on that domain may be a phish site, pornography site, etc. These relationships can easily be ascertained through the cross-indexing and cross-reference relationships supported by embodiments of the invention.

Trust evaluation system 102 may also provide a historical view of an entity's activities. Merely by way of example, if it is discovered that a given entity is engaging in an illicit activity, such as phishing, a record of the activity may be made with respect to that entity. Further, a record may be made with respect to each of the enabling parties associated with that entity, thereby tagging and/or labeling such enablers as being relatively more likely to facilitate illicit activities. Each time an enabling party is discovered to be a facilitator of such activity (and/or refuses to take corrective action when notified of such activity), a trust score may be adjusted. Trust score(s) may allow interested parties to determine quickly whether a given enabling party is relatively more or less likely to act as a facilitator of illicit activity, which can provide insight into the likelihood of a entity associated with such an enabling party to be engaged in an illicit activity and/or can allow the preparation of a complaint against an enabling party, etc.

As described in further detail below, embodiments of the invention may be used to provide a security and/or authentication service to users, companies, ISPs, etc. In such embodiments, for example, a trust provider may provide and/or maintain trust (reputational) and/or scoring databases for use by its customers. (A trust provider may be any entity that provides entity verification and/or evaluation services, including the scoring services discussed herein. A trust provider may also maintain and/or operate a trust evaluation system and/or may ensure the integrity of any replicated and/or cached trust or scoring databases, as described in detail below.) Such databases may be consulted to determine the relative reliability of various online entities in adhering to determined characteristics. In a particular embodiment, the scores may be, as noted above, analogous to credit scores, such that each entity is accorded a score based on its identifying information, relationship information, and history. Such scores may be dynamic, similar to credit scores, such that an entity's score may change over time, based on that entity's relationships, activities, etc. Merely by way of example, a scoring system from 1 to 5 may be implemented. A score of 1 may indicate the online entity has been verified and/or certified reliable by a provider of the trust evaluation system, such as through a certification process. A score of 2 may indicate that the entity is relatively likely to be reputable (that is, to be engaged only in legitimate activities), while a score of 3 may indicate that the identification and/or reputation of an entity is doubtful and/or cannot be authenticated, and scores of 4 or 5 indicate that the entity is known to be disreputable (e.g., engage in and/or facilitate illicit activity).

This exemplary scoring scheme is designed to be extensible, in that a plurality of scores may be accorded to any given entity, based perhaps on various characteristics and/or categories of activities. Merely by way of example, an entity may be accorded a number of scores based on that entity's likelihood of being involved in phishing and/or other fraudulent activities, brand abuse, pornography, e-commerce, online transactions, consumer targeting, preferred programs, service expedition, etc. (It may be noted from the above list that not all activities need to be illegitimate activities. Merely by way of example, a score indicating that an entity is likely to be engaged in e-commerce may allow a user to infer that a transaction with that entity is relatively more likely to be a legitimate transaction and/or may be used by a security system on a client and/or a border device (including those described below, for example) to make a determination that a transaction with such an entity is an allowable communication.

It should be noted that, while the above scoring scheme is used throughout several examples herein for illustrative purposes, the scheme is merely exemplary in nature, and that the procedure for evaluating and/or entities is discretionary.

In a set of embodiments, trust evaluation system 102 may provide trust score(s) as a relatively objective determination of the trustworthiness of an entity. A user, company, ISP, etc. may make its own determination of how to treat communications, data, etc. from an entity, based upon that entity's score. Merely by way of example, a company and/or ISP might configure its mail server to check the score of each entity from whom the server receives mail, and to take a specific action (e.g., forward the mail to its intended recipient, attach a warning to the mail, quarantine the mail, discard the mail, etc.) for each message, based on the score of the sending entity. As another example, a web browser might be configured to check the score of web site when the user attempts to access the site and take a specific action (e.g., block access to the site, warn the user, allow access to the site, etc.), based on the score of the web site (and/or an entity associated with the web site).

Trust evaluation system 102 may distribute trust score(s) using an enhancement of the current DNS and/or certification systems and/or a structure similar to the DNS structure. For instance, in some embodiments, trust evaluation system 102 may provide a root (authoritative) scoring server, and various entities (ISPs, etc.) might provide caching scoring servers. If a score lookup is needed, an assigned caching server might be consulted, and if that caching server has incomplete and/or expired scoring information, a root server may be consulted. Root servers might ultimately obtain scoring information from trust evaluation system 102, which may act as the authoritative server for the trust scores. In particular embodiments, however, unlike DNS, trust evaluation system 102 (and/or another trusted source), would have control over the dissemination of scoring information, such that the scoring servers could not be modified by third parties, and scoring information could not be compromised, either in transit or at the caching servers. Secure and/or encrypted transmission, authentication, non-repudiation and/or storage protocols thus might be implemented to ensure data integrity.

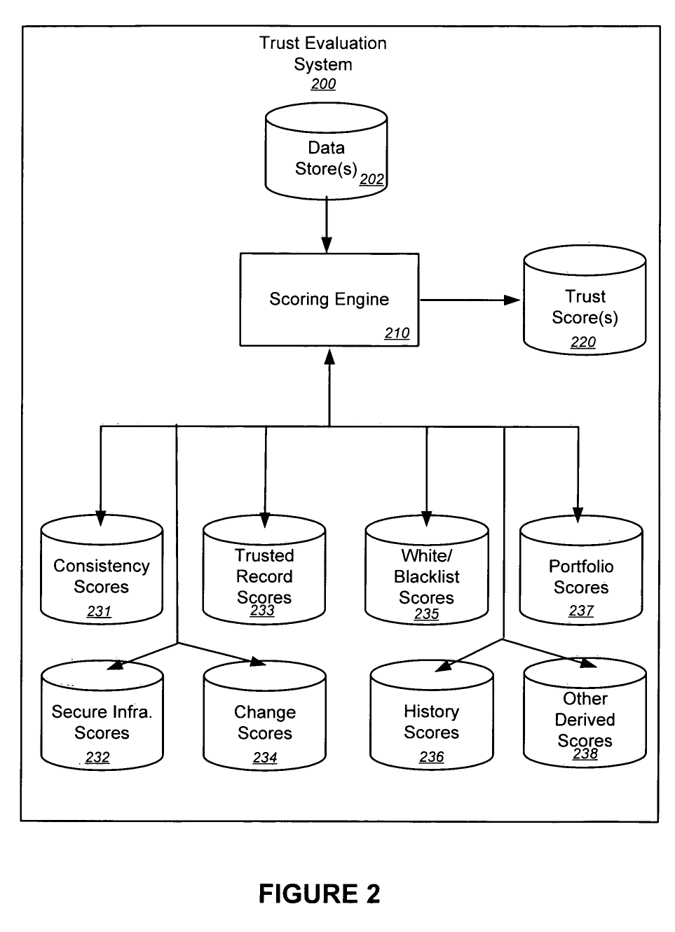

FIG. 2 illustrates an exemplary embodiment of a trust evaluation system 200. Trust evaluation system 200 may include one or more data stores 202. Data stores 202 may be used to store data gathered from a plurality of data sources (e.g., any of the data sources illustrated in FIG. 1) which has been cross-indexed and/or cross-referenced to correlate the data from the different sources. The gathering and/or correlation of the data may be performed by trust evaluation system 200 or other system.

Trust evaluation system 200 may further include a scoring engine 210 communicatively coupled with data store(s) 202. A communicative coupling is any type of coupling that allows communication between components (e.g., bus, external network connection, etc.). Thus, it should be appreciated that components which are communicatively coupled may reside on the same or different physical device(s).

Scoring engine 210 may calculate one or more trust score(s) for each of a plurality of online entities based on data 202 correlated to the respective online entity. Scoring engine 210 may also or alternatively calculate one or more derived score(s) 231-238 to evaluate a factor of data correlated to online entities. The derived score(s) 231-238 may optionally be used by scoring engine 210 to calculate trust score(s). As the data in data store(s) 202 may constantly or periodically be updated, scoring engine 210 may update trust score(s) and/or derived score(s) 231-238 on a periodic basis and/or upon detection of a specific event (e.g., an identification of a new fraudulent entity).

Derived score(s) 231-238 calculated by scoring engine 210 may be stored in one or more data stores (e.g., one or more relational databases, XML file(s), internal software list(s), or other suitable data structure). Alternatively, scoring engine 210 may dynamically calculate derived score(s) 231-238 as needed without storing calculated derived score(s) 231-238. In still further embodiments, scoring engine 210 may not calculate derived scores 231-238 at all.

One example of a type of derived score that may be calculated by scoring engine 210 is a consistency score 231. A consistency score for a particular online entity may evaluate a consistency factor of data associated with the online entity. For example, if the data correlated to an online entity indicates that all IP addresses associated with the online entity are on the same network, the online entity may receive a relatively high consistency score. Similarly, if IP addresses associated with the online entity are on a number of different networks, the online entity may receive a relatively low consistency score. As another example, the calculation of a consistency score may also or alternatively evaluate whether a quality of information associated with the online entity is consistent (e.g., WHOIS records are of a consistent quality and/or contain consistent information). Other information may also be evaluated by scoring engine 202 to determine consistency scores 231 for online entities.

Another type of derived score that that may be calculated by scoring engine for an online entity is a secure infrastructure score 232. Secure infrastructure scores 232 may be used to evaluate and score an online entity's use of security features, such as certificates. Other exemplary types of derived scores include trusted record scores 233 (evaluating and scoring entities based on the respective online entity's history with trusted data sources), change scores 234 (evaluating and scoring the frequency with which an online entity changes domain registrations), whitelist and/or blacklist scores 235 (evaluating and scoring an online entity's suitability for a whitelist (very high repute) or blacklist (disreputable)), history scores 236 (evaluating historical data to determine an entity's online history, lack of history and/or a quality of that history), portfolio scores 237 (evaluating and scoring the online entity based on whether an online portfolio (domain names owned, activities performed, etc.) associated with the online entity is compatible (makes sense) with the nature and character of the online entity), and/or any other type of derived score which evaluates a factor of correlated data associated with an online entity. Other scores can include application scores and virus scores, which can evaluate the trustworthiness of particular applications and/or malicious code (such that, when a user attempts to install such applications and/or code, the scores can be used to either advise the user on whether the application should be installed and/or make a determination (e.g., at an operating system and/or domain policy level) whether to allow or prohibit such installation).

Derived score(s) 231-238 may be calculated using any suitable data from data store(s) 202 or other derived scores for the particular derived score being calculated. Merely by way example, a portfolio score for an online entity, such as a corporation or entity associated with a corporation (e.g., IP address), may include factors such as a size of the corporation (which may be determined from data derived from corporate records) and/or a number of IP addresses owned by the corporation (obtained from correlated WHOIS data, DNS data, etc.). As another example, a calculation of a secure infrastructure score may include a factor counting a number of certificates associated with an online entity, number of unsecured servers associated with the entity, etc. It should be appreciated that numerous other types of calculations are possible and that embodiments may use a variety of techniques to calculate derived scores based on types of data available in the data store 202 and/or varying requirements for the derived scores being calculated.

Scoring engine 210 may use derived scores 231-238 and/or correlated data obtained from data store(s) 202 to calculate one or more trust scores for an online entity. Any type of statistical analysis (e.g., direct, Bayesian, fuzzy, heuristic, and/or other types of statistical relationships) may be used by scoring engine 210 to calculate trust score(s). Trust score(s) may be dynamic, such that an entity's score may change over time based on that entity's relationships, activities, or other factors. As with credit card scores(s), competing trust evaluation systems 200 may vary on the factors and algorithms used to calculate trust score(s).

Trust score(s) that are calculated for a particular type of entity may use any type of data correlated with the online entity as factors in the calculation. Merely by way of example, a trust score for an IP address may include factors related to the individual or corporate entity owning the IP address, such as information obtained from corporate records, judicial records, or other type of data source. These relationships may be discovered and/or analyzed by an identity tracking system, such as the systems described in the Online Identity Tracking Application, to name but a few examples. In further aspects, scoring engine 210 may use a trust score for a first online entity as a factor in calculating a trust score for a second online entity associated with the first online entity. Thus, if an IP address has a poor trust score (as derived by embodiments of the invention), other IP addresses owned by the same entity may receive a poor or doubtful trust score by association (especially if the owner of the addresses is an authenticated entity). Third party ratings for various characteristics being scored might also be consulted in determining scores.

Other factors may also be used in the calculation of trust score(s). By way of example, trust evaluation system 102 may include a feedback loop that allows entities to communicate feedback on trust scores. Received feedback may be included in subsequent calculations of the trust score for the online entity associated with the feedback. Safeguards may be provided to ensure that feedback communications can not unduly sway trust scores. Feedback may originate from customers of the provider of the trust evaluation system 102 or others, based on the experiences of the customers and/or the customers'/entities' own scoring evaluation(s). Feedback from systems such as those described in U.S. patent application Ser. No. 11/237,642, already incorporated by reference, may also be used.

In one set of embodiments, scoring engine 210 may calculate overall trust scores using a scoring system from 1 to 5. Scores of 1 or 2 may indicate that the entity is relatively likely to be reputable (that is, to be engaged only in legitimate activities), while a score of 3 may indicate that the identification and/or reputation of an entity is doubtful and/or cannot be authenticated, and scores of 4 or 5 indicate that the entity is known to be disreputable (engage in and/or facilitate illicit activity). Other scoring mechanisms may also be used to calculate an online entity's overall reputation and/or trustworthiness.

Trust score(s) 210 may be stored in a trust data store 220, which may be made available and distributed by any appropriate mechanism, including without limitation those described below. Trust scores may each be associated with an identifier (e.g., domain name, corporation name, personal name, IP address, etc.) identifying the online entity associated with the respective score. In some embodiments, scoring engine 210 may calculate overall trust score(s) for IP addresses and/or domain names and/or may associate an entity's trust score (e.g., owner of IP address/domain) with IP addresses correlated to the entity as well as, optionally, associated enabling parties. This may provide for the ability of trust scores to be easily and rapidly distributed. Optionally, IP addresses and/or domain names (or other type of online entity) with little or no available information (and/or that cannot be authenticated) may be assigned an initial score by scoring engine 210. In some aspects, a relatively neutral or uncertain score may be assigned such entities. In other cases, unknown entities may be assumed reputable (or disreputable). In a set of embodiments, the quality of the score might be quantified. Merely by way of example, a score that is the result of multiple independent scoring processes might be considered more reliable than a score that is provided by a single third party and has not been verified as accurate.

In some aspects, scoring engine 210 may also calculate specific types of trust scores. Merely by way of example, with respect to a particular online entity, scoring engine 210 may calculate a fraud trust score that evaluates the entity's reputation for and/or likelihood to be engaged in fraudulent activity. As another example, scoring engine 210 may calculate a virus trust score evaluating an entity's reputation for and/or likelihood to be engaged in perpetrating and/or perpetuating viruses. A third example is an unwanted traffic score evaluating the entity's reputation for and/or likelihood to be engaged in distributing unwanted traffic (spam, pornography, pop-up messages, malicious code, etc.). A fourth example is a cybersquatting trust score evaluating the entity's reputation of and/or likelihood of being a cybersquatter. Other specific types of trust scores related to a particular type of behavior may also be calculated by scoring engine 210. Thus, an online entity may have a plurality of associated trust scores, some or all of which may be stored in data store 220 and/or a plurality of data stores.

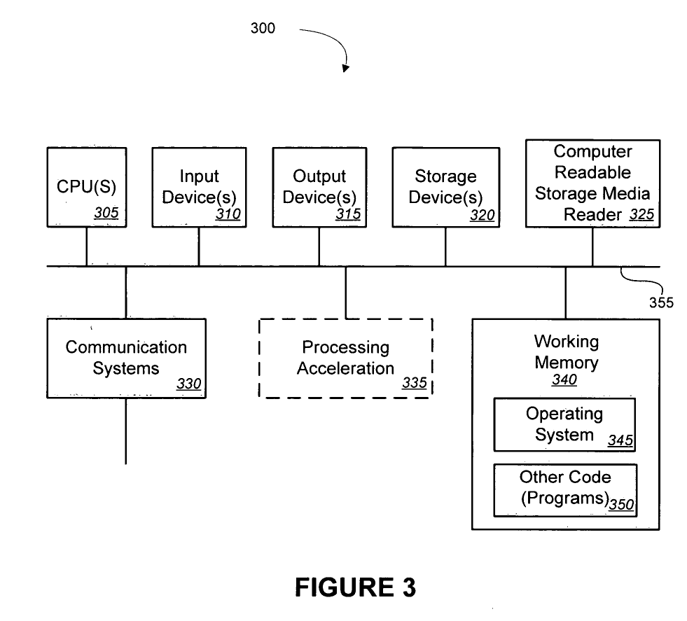

FIG. 3 illustrates one embodiment of a computer system 300 upon which a trust evaluation system (or components of a trust evaluation system) may be implemented. The computer system 300 is shown comprising hardware elements that may be electrically coupled via a bus 355. The hardware elements may include one or more central processing units (CPUs) 305; one or more input devices 310 (e.g., a mouse, a keyboard, etc.); and one or more output devices 315 (e.g., a display device, a printer, etc.). The computer system 300 may also include one or more storage device 320. By way of example, storage device(s) 320 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 325; a communications system 330 (e.g., a modem, a network card (wireless or wired), an infra-red communication device, etc.); and working memory 340, which may include RAM and ROM devices as described above. In some embodiments, the computer system 300 may also include a processing acceleration unit 335, which can include a DSP, a special-purpose processor and/or the like

The computer-readable storage media reader 325 can further be connected to a computer-readable storage medium, together (and, optionally, in combination with storage device(s) 320) comprehensively representing remote, local, fixed, and/or removable storage devices plus storage media for temporarily and/or more permanently containing computer-readable information. The communications system 330 may permit data to be exchanged with a network and/or any other computer.

The computer system 300 may also comprise software elements, shown as being currently located within a working memory 340, including an operating system 345 and/or other code 350, such as application program(s). Application program(s) may implement a trust evaluation system. It should be appreciate that alternate embodiments of a computer system 300 may have numerous variations from that described above. For example, customized hardware might also be used and/or particular elements might be implemented in hardware, software (including portable software, such as applets), or both. Further, connection to other computing devices such as network input/output devices may be employed.

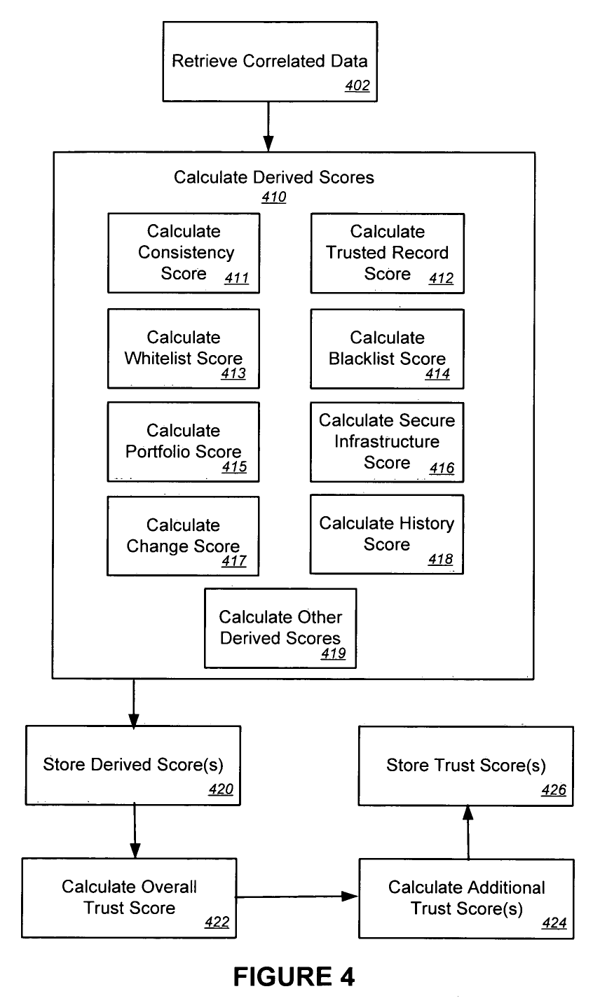

FIG. 4 illustrates an exemplary method that may be used by a trust evaluation system to evaluate a the trustworthiness of an online entity. Data associated with an online entity may be retrieved 402 from one or more data sources. The data may have been compiled from a plurality of data sources and/or correlated as described above.

Optionally, one or more derived scores for the online entity may be calculated 410, perhaps based on the correlated data. Each calculated derived score may evaluate a factor of the data associated with the online entity. Derived score(s) calculated 410 for the online entity may comprise one or more of a consistency score 411, a trusted record score 412, a whitelist score 413, a blacklist score 414, a portfolio score 415, a secure infrastructure score 416, a change score 417, a history score 418, and/or other derived scores (including without limitation a compliance score, a data integrity score, an association score, a score related to the entity's facilitation of the illegitimate activities of others, etc.). In some embodiments, derived score(s) may be stored 420 for future use or reference. Further details about the particular types of derived scores mentioned by way of example are described above with reference to FIG. 2.

An overall trust score for the online entity may be calculated 422 based on the correlated data associated with the online entity. In some aspects, calculating 422 the overall trust score may include the use of calculated derived scores (such as the scores 411-419 discussed above) which evaluate one or more factors of the correlated data. In some embodiments, calculating 422 the overall score may comprise assigning the online entity a score from 1 to 5, with 1 indicating the entity is relatively likely to be reputable and 5 indicating the entity is relatively likely to be disreputable. Other scoring mechanisms may also be used.

In some aspects, one or more additional trust score(s) may also be calculated 424 for the entity. Additional trust score(s) may include a fraud trust score, a virus trust score, an unwanted traffic trust score, a cybersquatting trust score, examples of which are described above, and/or other specific types of trust scores. Some embodiments may not include the calculation 424 of additional trust scores.

The overall trust score and/or additional trust score(s) may be stored 426 in one or more trust data stores, perhaps along with an identifier identifying the online entity. The scores and/or other reputational information may then be made available to clients of trust evaluation system 200 and/or may be distributed, e.g. as described below.

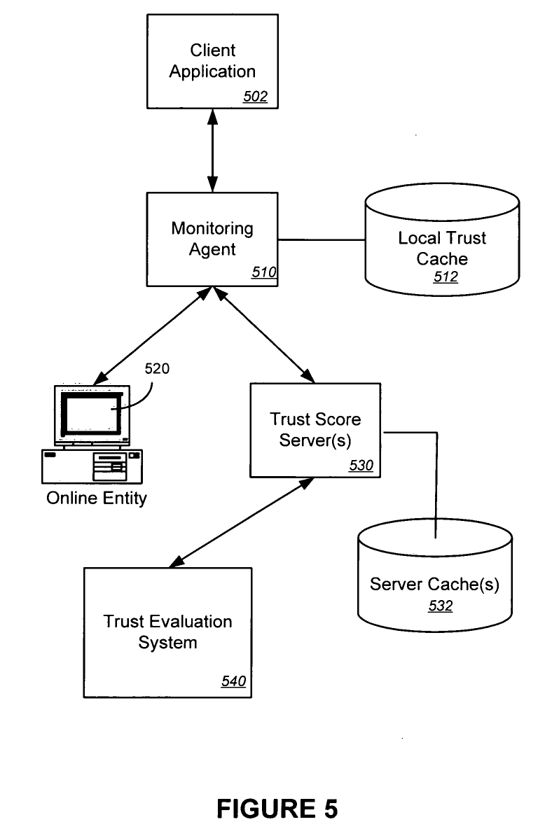

FIG. 5 illustrates an exemplary system that may be used to distribute and/or acquire trust data. The system includes a client application 502 communicatively coupled with monitoring agent 510. Client application 502 may be any type of application engaging in communications with online entities 520. By way of example, client application 502 may be a email application or a web browser application

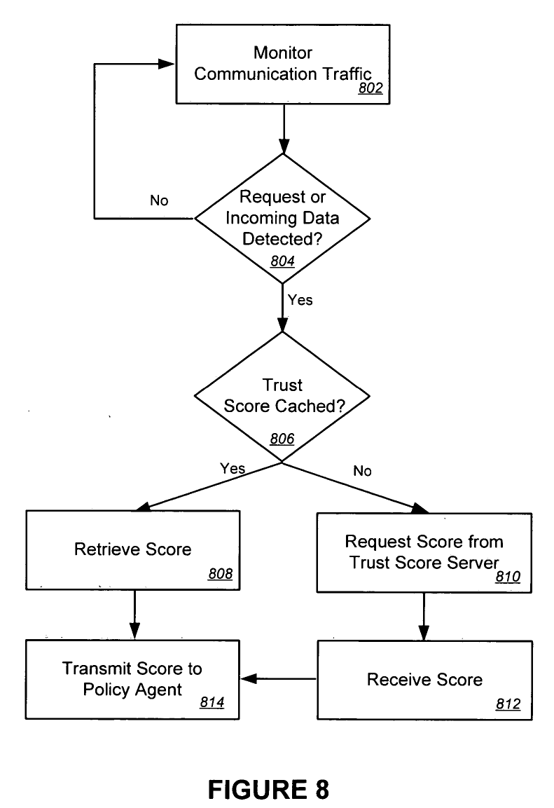

Communications transmitted from and/or received by client application 502 may be monitored by monitoring agent 510 or other component. Upon detection of a communication associated with an online entity (e.g., request for data from the online entity or inbound communication received from the online entity), monitoring agent 510 may obtain one or more trust score(s) associated with the online entity. In some embodiments, monitoring agent 510 may first determine if the trust score(s) for the online entity are cached in a local trust cache 512. If not, monitoring agent 510 may issue a request to a trust score server 530 for the online entity's trust score(s). Further details of a process that may be used to acquire trust data are described below with reference to FIG. 8.

In some embodiments, monitoring agent 510 may reside on a border device (such as a firewall, proxy, router, etc.) that serves as a gateway to a network. In other embodiments, monitoring agent 510 may reside on the same computer as client application 502 or different computer. It should be appreciated that monitoring agent 510 may be a component of an operating system and/or a larger application (e.g., a native component, plug-in component, and/or a toolbar of a web-browser application, an email application, a gateway/firewall application, an anti-virus application, an anti-fraud application, a security suite, etc.) or may be a standalone application.

As previously described, trust evaluation system 540 may evaluate and create trust score(s) for online entities based on correlated data compiled from one or more sources. Trust evaluation system 540 may distribute trust score(s) using a structure similar to DNS. Thus, trust evaluation system 540 may maintain one or more authoritative trust data stores(s). Trust evaluation system 540, or authoritative database(s) component(s) of trust evaluation system 540, may be in communication with one or more trust score servers 530, which cache 532 at least a subset of the trust score(s).

In various embodiments, some of the trust score server(s) 530 may be root servers and/or core servers that receive trust scores from trust evaluation system 540. Trust scores may be transmitted to root servers using any or both of a pull mechanism (upon request of root server) or a push mechanism (at the initiation of trust evaluation system 540). Root servers may then be responsible for providing trust scores to a set of trust score servers 530 at a lower hierarchical level in the distribution chain. A different type of organizational structure of trust score server(s) 530 may also be used. In particular embodiments, for example, a system similar to DNS might be used, such that root (and/or core) servers contain pointers to one or more authoritative servers that have score information for requested entities. In other embodiments, however, each root (and/or core) server may have a complete and/or partial copy of one or more score databases, and may provide scores upon request (e.g., if a caching server and/or local cache does not have a score).

In a particular set of embodiments, there may be a plurality of authoritative trust servers (which may be trust evaluation systems, as described above, and/or servers in communication with a trust evaluation system). The authoritative trust servers, as noted above, serve as an authoritative source for trust scores; in some embodiments, each authoritative trust server may be responsible for a subset of trust scores. Merely by way of example, trust scores may be grouped by type of score (e.g., one authoritative trust server may be responsible for a set of trust scores related to one characteristic and/or category of behavior or interest, such as phishing, while another authoritative trust server is responsible for a set of trust scores related to another characteristic and/or category of behavior or interest, such as pornography). Characteristics of interest, for example, can be used for specific filtering criteria and/or selective searching of entities.

Alternatively and/or in addition, different authoritative servers may be used to implement different scoring criteria and/or scales, depending on the implementation. Thus, for example, a first authoritative server may have scores on a scale of 1-5 for a plurality of entities, while a second authoritative server may have scores on a scale of 1-25 for the same plurality of entities. A third authoritative server may simply contain blacklists, whitelists, and/or greylists of entities (which lists may be compiled based on trust scores).

In further embodiments, each of a plurality of authoritative trust servers may be responsible for trust scores for a subset of entities. Merely by way of example, it may be advantageous to divide a plurality of entities based on geographic location of the entity, top level domain (“TLD”) of the entity, etc., and to provide an authoritative trust server responsible for each of these divisions. Alternatively and/or in addition, some embodiments may provide multiple authoritative trust servers, each of which is adapted to a particular locale and/or language.

Hence, there are a variety of ways in which multiple authoritative trust servers may be implemented. In accordance with embodiments of the invention, then, a root server and/or a local trust cache may be configured to include pointers to the appropriate authoritative trust server(s), depending on the score desired (e.g., on the type of behavior, the language, the location of the client and/or the entity being looked up, on the scale desired, etc.).

In some embodiments, to facilitate rapid transfer of trust scores upon request, trust scores for online entities may be associated with a particular type of identifier of the online entities, such as a domain name or IP address. Other structures may also be used to distribute trust scores. In some cases, trust evaluation system 540 may have sole authority to create and modify trust score(s) to enhance the security of scoring information. Additionally, cache entries maintained in server caches 532 and/or local caches 512 may expire after a predetermined time in order to reduce the use of outdated scores in making decisions about communications from online entities.

According to one set of embodiments, each trust score server 530 at a hierarchical level below the trust evaluation system 540 may be responsible for a particular set of online entities. In some embodiments, sets of online entities may be determined based on predictive caching algorithms. Other methods may also be used to segregate online entities. When initially populating and/or updating server caches 532 maintained by trust score servers 530, trust evaluation system 540 may only distribute trust scores(s) to a trust score server 530 that are associated with the online entities for which the respective trust score server 530 is responsible. Trust score servers 530 at a higher hierarchical level 530 may distribute its entries or a subset of its entries to additional trust score servers at a lower hierarchical level. If a trust score server 530 receives a request for an entry that is not included in its cache 532, the request may be passed up to the next hierarchical score server 530. The authoritative server may be trust evaluation system 540. When entries are passed back down, they may be cached 532 by the trust score server(s) 530 through with the entries are passed.

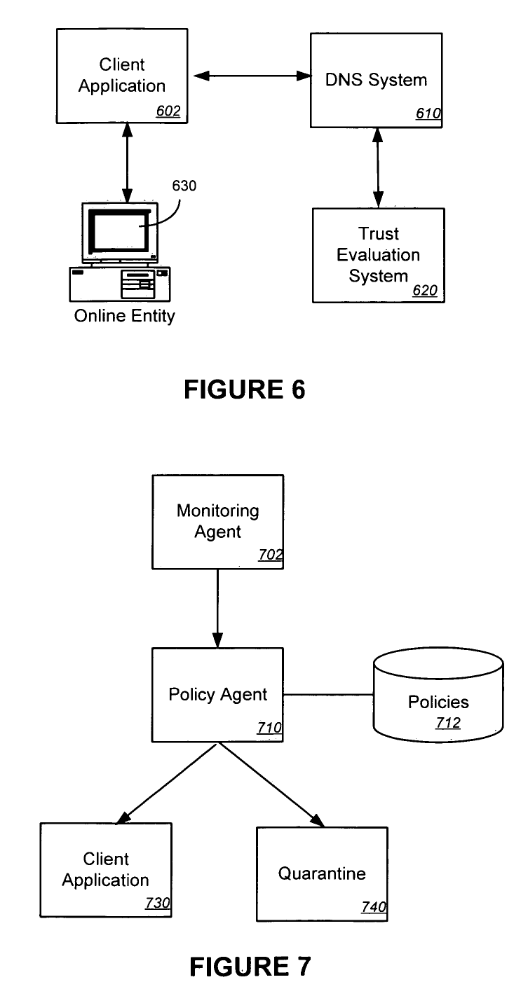

FIG. 6 illustrates a second exemplary embodiment of a system that may be used to distribute trust data. Trust evaluation system 620 may evaluate and create trust scores for online entities as previously described. A trust data store (not shown) may maintain trust scores that are associated with an IP address and/or a domain name. In some embodiments, an IP address and/or domain name may be associated with a plurality of trust scores, such as an overall score and any of the additional types of trust scores described above. The trust scores associated with IP addresses and/or domain names may be transmitted by trust evaluation system 620 to a DNS system 610.

One or more servers in DNS system 610 may maintain DNS records that include the trust scores and/or point to an authoritative source for such scores. These may be, for example, standard DNS records that have been modified to include a trust score. Of course, based on the disclosure herein, one skilled in the art will appreciate that access controls may be implemented to allow an entity to update that entity's standard DNS information but not to allow unauthorized updates or modifications of the trust scores. Upon receiving a DNS lookup request, a DNS server may transmit one or more trust scores associated with the IP address to a requesting client application 602. Client application 602 may then use the trust score(s) to determine whether to allow, block, quarantine, warn, or take other action on communications associated with the online entity 630.

FIG. 7 illustrates an exemplary system that may be used to implement trust policies. Once a trust score for an online entity has been retrieved by monitoring agent 702 and/or other component, a policy agent 710 may be used to determine one or more actions to apply to communications associated with the online entity. By way of example, actions a policy agent may take include blocking a communication, allowing a communication, quarantining a communication, and/or warning a user of client application 730, an administrator, or other person or computer application. Policy agent 710 may apply actions to outbound communications from a client application 730 to an online entity and/or inbound communications received from an online entity.

Policy agent 710 may be a standalone program and/or a component of a larger program, such as an operating system, email application, a gateway application, or a web browser application, as described in more detail above. Thus, in some embodiments, policy agent 710 may be implemented on a client computer which executes client application. In other embodiments, policy agent 710 may be implemented on a border device, such as an enterprise router, a proxy server, a firewall server, or any other computer. A policy agent 710 may provide a variety of policies (and/or there may be a plurality of policy agents 710) designed to take different actions based on specific categories of scores and/or to provide application-specific behavior based on a given score. Merely by way of example, a given score may be treated differently in different circumstances—a pornography score of 3 may be assigned a more restrictive policy than a spam category of 3, for example, and/or an email. message from an entity accorded a spam score of 4 might be quarantined or blocked, while a web page from the same entity might be allowed.

One of the actions taken by policy agent 710 may be to quarantine communications. Hence, the system may include a quarantine area 740. Quarantine area 740 may provide a safe area for users, administrators, and/or others to view communications. Alternatively, access to the quarantine area 740 may be restricted to administrative or authorized users. Quarantine area 740 may provide a “sandbox”, as is known in the art, to allow the safe execution of email attachments, scripts, web pages and/or the like. Hence, the quarantine area 740 can allow “locked down” access to quarantined data, allowing a user (and/or another) to access the data without exposing the system to potential threats contained within the data.

In some aspects, policy agent 710 may determine the action(s) to take based on one or more policies 712. Policies 712 may define actions to be taken based on ranges or threshold score values. By way of example, in embodiments using the 1-5 scoring system previously described, policies 712 may indicate that communications to and/or from online entities with a trust score of 5 (disreputable) are blocked or dropped. A trust score of 4 may be associated with a policy 712 to quarantine communications from the online entity, while a trust score of 3 may be associated with a policy 712 to warn a user, administrator, or other party or system. Policies 712 may further indicate that communications associated with online entities having a trust score of 1 or 2 are allowed (passed). It should be appreciated that in other embodiments, policies 712 may include different types of policies, which may vary based on the scoring system used to evaluate the trustworthiness of online entities. Additionally, some embodiments may include policies 712 which make use of additional trust scores (e.g., a fraud trust score, an unwanted traffic trust score), e.g., to take specific actions based on the threat implied by the additional trust score(s). Moreover, as mentioned above, while the exemplary 1-5 scoring scheme is designed to be efficient, it may be expanded, contracted and/or otherwise modified in specific implementations.

FIG. 8 illustrates an exemplary method that may be used to evaluate a communication and/or to obtain trust data. Communication traffic to and/or from one or more client applications may be monitored 802 at the client, a border device, or other system. If an inbound and/or outbound communication associated with an online entity is detected 804, at least one trust score associated with the online entity is obtained as described in blocks 808-812. Otherwise, monitoring 802 of communication traffic may continue. In other embodiments, communication traffic may not be monitored 802. Instead, the client application may detect 804 the inbound or outbound communication and may then obtain or request the trust score.

In one set of embodiments, the trust score may be obtained by first determining 806 if a local trust cache includes the trust score. If the trust score is cached (and is not expired), the trust score is retrieved 808 from the local trust cache. Otherwise, a request for the trust score may be requested 810 from a trust score server.

The trust score server to which the request is sent may be responsible for providing trust scores to the computer (e.g., client computer, gateway computer) associated with the requester. As previously described, if a cache associated with the trust score server does not include the requested trust score, the trust score server may issue a request to another trust score server and/or trust evaluation system to obtain the requested trust score. Any of the trust score servers and/or the trust evaluation system itself may transmit the trust score back to the requesting computer. In one set of embodiments, the trust score and/or a pointer to the appropriate trust score server may be transmitted back down the hierarchical chain, which may provide for the caching of the trust score for future requests. In an aspect, a trust score request might use the following priority: First a request is made to a peer server; if no trust information is found, a request may be made to a higher-level server. This process can continue until a request is made to a known authoritative server (or root server, if appropriate). In some cases, a server at each level of the hierarchy might proxy for servers (and/or clients) at lower levels of the hierarchy in making requests to higher levels of the hierarchy. In such cases, the ultimate response to the request can then be propogated back down the hierarchy, and caches at each level may be updated if appropriate.

Once the trust score has been retrieved 810 or received 812 at the computer requesting the trust score, the score may be transmitted 814 to a policy agent (which may be a separate program or a component of a program which obtained the trust score). Policy agent may then determine action(s) to apply to the communication associated with the online entity.

It should be appreciated that in alternative embodiments, trust scores may be acquired using a process different than that described with reference to FIG. 8. For example, the trust score may be acquired from a DNS record. Other processes may also be used.

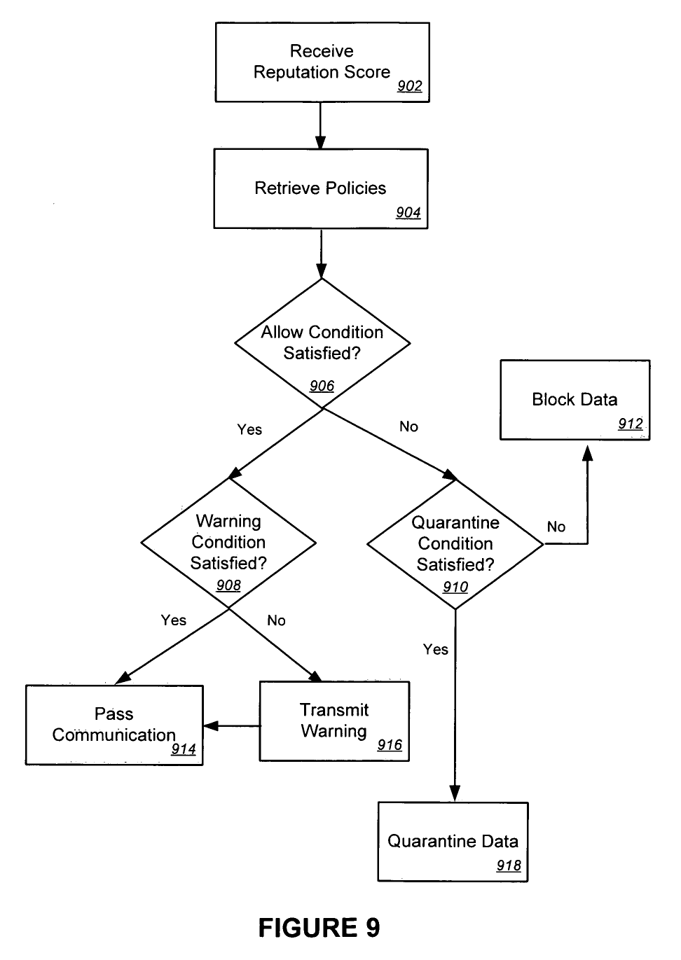

FIG. 9 illustrates an exemplary method that may be used to implement trust policies. A trust score associated with an online entity may be received 902 by a policy agent. A policy agent may be a component of an operating system, a web browser application, an email application, a gateway application, and/or any other type of application (including those discussed above), and/or may be a standalone application. In one set of embodiments, one or more trust policies may be retrieved 904 and applied based on the trust score.

Trust policies retrieved 904 may indicate action(s) to apply to a communication associated with the online entity based on the trust score. In some aspects, trust policies may be applied by comparing the trust score to one or more values associated with a trust policy. Merely by way of example, if an allow policy condition is satisfied 906, the communication may be allowed. Before passing the communication, the method may also include evaluating a warning policy to determine whether a warning should be attached to the communication. If a condition associated with a warning policy is satisfied 908, a warning to a user may be transmitted 916. With or without the warning, the communication may then be passed 914 either to the online entity (if it was an outbound request) or to a client application (if it was an inbound communication received from the online entity). Some embodiments may provide an option to the user receiving the warning to block and/or quarantine the communication before it is passed 914.

If the allow condition was not satisfied 906, additional policies may be evaluated to determine the action to apply to a communication. Merely by way of example, if a condition associated with a quarantine policy is satisfied 910, the communication may be quarantined 918. Optionally, the client application and/or user associated with the communication (either initiating or receiving the communication from the online entity) may be notified the communication was quarantined. If the allow policy conditions are not satisfied and the quarantine policy conditions are not satisfied, the communication may be blocked 912 and/or dropped (filtering for interests and/or preferences can work in a similar way). The client application, user, sender, and/or other party may be notified that the communication was blocked 912.

In alternative embodiments, trust policies may be implemented differently than described with reference to FIG. 9. For instances, additional, fewer, or different policies may be applied to a trust score and/or policies may be applied in a different order. Other variations are also contemplated.

It should be appreciated that trust scores which evaluate the trustworthiness and/or reputation of online entities have a wide range of applications. For exemplary purposes, consider a situation in which a server attempts to send an email message to a user using a mail client on a user computer. The sending server routes the message (usually via the Internet) to the mail server for the user's ISP (or corporation, etc.). In accordance with embodiments of the invention, the mail server, upon receiving the message, examines the message to determine an identifier (such as a host, domain, IP address, etc.) of the sending server. The mail server then queries a local trust caching database for scoring (or other) information about the sending server. If the caching database has relevant information that has not expired, the caching database (and/or a server associated therewith), transmits this information to the mail server. If the caching database does not have the requested information (or has an expired version of the information), the caching database (or, again, a server associated therewith), may refer the mail server to, and/or forward the request to, an authoritative database, a root database or server, etc., perhaps in a fashion similar to the caching and retrieval methods implemented by DNS systems (perhaps with some modification, such as the provision of an entire score database to one or more core servers), and such a database or server provides the requested information, either to the caching database and/or the mail server. Upon receiving the scoring information, the mail server (e.g., a policy agent component of the mail server) may make a determination of how to handle the message, including without limitation any of the options mentioned above. In some aspects, if scoring information is not available, the mail server may assume the sender is disreputable (or reputable).

As a second example, when a user (using a client application, such as a web browser) attempts to access a web page at a web server, a proxy server (e.g., a monitoring agent component of the proxy server), before transmitting the HTTP request (and/or the response from the server), may consult a caching database in a manner similar to that mentioned above. Based on trust scoring information received, the proxy server may determine an appropriate action to take, including without limitation any of the actions mentioned above.

Alternative configurations are possible as well. Merely by way of example, it may be more appropriate in some situations (such as when a client and mail server are configured with a POP3 relationship, and/or when a client does not use a proxy server to access the Internet), for software on the client to obtain trust scores and determine actions to apply to communications based on the trust scores. For instance, a software firewall on a client could be configured to limit incoming and outgoing transmissions according to a trust score accorded the transmitting/receiving server, domain, etc. Alternatively and/or in addition, other types of applications (such as mail clients, web browsers, etc.) may also be configured (e.g., through options, plug-ins, tool bars, etc.) to use trust scores.

Other applications of the present invention are possible as well, including integration with additional systems. For instance, the Anti-Fraud Applications disclose a number of fraud prevention and/or detection systems, which embodiments of the present invention may incorporate, and/or embodiments of the invention may be integrated with, and/or be operated in conjunction with such systems. Merely by way of example, an exemplary system disclosed by the Anti-Fraud Applications is a system designed to monitor records modified in or added to a zone file and monitor any domains associated with the added/modified records for activity. A set of embodiments of the present invention may be integrated with such systems. For example, if a new domain record is found in the monitoring of a zone file, the trust score of one or more entities associated with the new domain record (e.g., an owner of the new domain, an enabling party for the new domain, etc.) may be provided by an embodiment of the present invention. Depending on the trust score, then, a determination may be made regarding whether the new domain presents a likely threat of illegitimate activity (such as phishing, trademark misuse, cybersquatting, etc.), and the trust score of the associated entities may be used to inform a decision whether (and/or how) to monitor the new domain for activity.

Merely by way of example, if a new domain is registered by an entity with a high trust score (indicating a relatively low probability of illegitimate activity), the domain may be monitored relatively less aggressively and/or may not be monitored at all. In contrast, if an entity with a relatively low trust score (and/or an unknown entity) registers a domain, that entity's trust score (and/or lack thereof) may prompt a decision to monitor the trust score relatively more aggressively, especially if the domain is associated with one or more enabling parties (such as registrars, ISPs, etc) having relatively low trust scores.

Conversely, various systems integrated with embodiments of the invention (and/or operated in conjunction with embodiments of the present invention) may be used to provide data sources for a trust database, as discussed above. Merely by way of example, if the monitoring system of the previous example determines that a new domain is involved in illegitimate activity (such as phishing, cybersquatting, etc.), that determination may be used as data to calculate and/or update one or more trust scores for the entity operating the domain and/or any associated entities (which could include enabling parties, affiliated entities, and the like).

An identity tracking system, such as the systems disclosed in the Online Identity Tracking Application, may be integrated, incorporated and/or operated in conjunction as well. For instance, in the examples above, an identity tracking system may be used to identify an entity registering and/or operating a new domain, and/or any associated entities (which, again, could include enabling parties, affiliated entities, etc.), and/or to provide data for the development and/or update of a trust score for the entity.

Merely by way of example, if a new domain is registered (and/or ownership or other information for a domain is modified), the registration record may be parsed for pertinent information (which can be any information that may be used to identify an entity associated with the domain registration, such as corporate name, contact name, address, telephone number, contact email address, etc.), and such information may be used as input to an identity tracking system. The identity tracking system, then, may search for such information and/or related information in an identity tracking database (as disclosed in the Online Identity Tracking Application, for example). Such information thus may be used to identify records related to one or more entities associated with the new domain (including without limitation the owner of the domain, any associated and/or affiliated parties, enabling parties, etc.).

The identity tracking system may also be used for additional diagnostic purposes. In a particular case, for example, if the new domain name registration is for a domain name similar to the name of a client of the trust provider (which may indicate that the new domain might be used for cybersquatting, phishing and/or some other unsavory activity), the identity tracking system can search the identified records for any records indicating ownership of (and/or any other association with) any other similar domains (such as domain names related and/or similar to the customer's brand name(s), domain name(s) and/or trademark(s); the customer's industry; other companies in the customer's industry; etc.), which may indicate that an entity associated with the new domain registration is engaging in a practice of acquiring such domains, a possible indicator that the entity is engaging in (and/or plans to engage in) one or more illegitimate activities.

This indication may be used in several ways. First, a notification may be provided to an operator of the identity tracking system, the trust evaluation system and/or another that further investigation and/or monitoring may be appropriate. Alternatively and/or in addition, such monitoring and/or investigation may be undertaken automatically (using, for example, one or more of the systems described in the Anti-Fraud Applications). In particular embodiments, an event may be created in an event manager (described in detail in the Anti-Fraud Applications), allowing for the initiation, tracking and/or management of any appropriate fraud detection and/or prevention processes.

Second, one or more trust scores of any associated entities may be updated, using, for example, methods described above. Alternatively and/or in addition, one or more records may be updated in the identity tracking system to indicate an association and/or correlation between the owner of the new domain (as well as any affiliated parties, enabling parties, etc.) and entities identified by the identity tracking system as associates of those entities.

There are additional applications of embodiments of the present invention as well. Merely by way of example, implementations might include the use of a toolbar, plug-in, and/or the like that could be integrated and/or used with a client application (including without limitation those client applications discussed above, such as web browsers, electronic mail clients, instant messaging and/or Internet chat clients, and the like). As mentioned above, a toolbar might be configured (using a policy manager and/or other software component) to obtain trust scores for entities with whom a user communicates using the client application. Alternatively and/or in addition, a toolbar (and/or any other software component, such as a firewall application, client application, etc.) might be configured to implement whitelists, blacklists and/or greylists, which might be based on trust scores for various listed entities. In a particular set of embodiments, a toolbar (and/or another component) might be configured to receive a list of entities compiled by a trust server, root server and/or any other of the systems described above, based on the trust scores of those entities. Entities scored with a 1, for example, might be added to a whitelist, while entities scored with a 4 or 5 might be added to a blacklist. Such toolbars and components can also be used to provide filtering by preference and/or interest, based on interest scores assigned to various entities and/or communications.

In one aspect, one or more greylist(s) might be implemented as well, which could include entities scored with a 3 and/or entities associated (perhaps to a degree specified by a user, administrator and/or a trust provider) with entities scored with a 4 or a 5. Merely by way of example, if an entity is scored with a 5 (meaning the entity is relatively untrustworthy), any closely-associated entities (which might be defined to mean any entities with the same telephone number, contact email address, etc.) are added to a greylist. (Of course, based on the disclosure herein, one skilled in the art will appreciate that a variety of criteria may be used to defined the degree of association that will cause an entity to be placed on a greylist.) In another set of embodiments, the scoring system might be unnecessary. Merely by way of example, if an entity is known (e.g., by a trust provider) to have engaged in fraud, that entity might be added to a blacklist, and/or any entities associated (to whatever degree is deemed appropriate) with that entity might be added to a greylist.

In a particular set of embodiments, a plurality of greylists may be supported. Merely by way of example, a first greylist might comprise entities known to be associated with blacklisted entities, as discussed above. A second greylist might comprise entities suspected (but perhaps not known) to engage in illegitimate activities and/or unwanted communications. Further, there may be a plurality of blacklists, whitelists and/or greylists corresponding to various behavior characteristics and/or categories of activities, including without limitation those categories and/or characteristics discussed above. Merely by way of example, there may be a first list (and/or set of lists—black, white and/or grey) related to entities' likelihood to transmit spam, a second list (and/or set of lists) related to entities' likelihood to be purveyors of pornography, a third list (and/or set of lists) related to entities' likelihood to be engaged in legitimate online commerce, etc. These lists may be used by a user, administrator, etc. to customize the behavior of one or more client applications with respect to entities on the various lists.

The toolbar (or other component) then, might be configured to automatically allow access to communications (e.g., email messages, web pages, etc.) with whitelisted entities, automatically block access to communications with blacklisted entities, and/or to take some other action with respect to communications with greylisted entities. Other actions, including those discussed above, such as warning, quarantining, etc. are possible as well. If desired, a policy manager (and/or filtering engine) might be used to define the behavior of a toolbar (or other component) with respect to each type of entity. In some cases, a user might be given the ability to modify the blacklist, whitelist and/or greylist (e.g., by adding or removing entries manually, and/or by selecting an option—from a toolbar button, context menu, and/or the like—when viewing a communication from a given entity, to add that entity to a blacklist, whitelist or greylist) and/or to modify the application's behavior with respect to each type of list. In other cases, the lists (and/or the application's behavior) might be administratively controlled by a local administrator, a trust provider, etc.

In accordance with particular embodiments, the toolbar (or other component) might be fed updates automatically from a central location (e.g., a trust evaluation system) and/or through a distributed network of caching servers, etc. Updates might be automated at the client and/or the server(s), and/or might be performed on demand as requested by the client. A variety of updating schemes (such as for operating system updates, virus definition updates, etc.) are known in the art, and any of these updating schemes may be used as appropriate in accordance with various embodiments.

In the foregoing description, for the purposes of illustration, methods were described in a particular order. It should be appreciated that in alternate embodiments, the methods may be performed in a different order than that described. Additionally, the methods may include fewer, additional, or different blocks than those described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In conclusion, the present invention provides novel solutions for evaluating the trustworthiness of various online entities, and for distributing and/or using such information. While detailed descriptions of one or more embodiments of the invention have been given above, various alternatives, modifications, and equivalents will be apparent to those skilled in the art without varying from the spirit of the invention. Moreover, except where clearly inappropriate or otherwise expressly noted, it should be assumed that the features, devices and/or components of different embodiments can be substituted and/or combined. Thus, the above description should not be taken as limiting the scope of the invention, which is defined by the appended claims.

What is claimed is:

1. A method comprising:
detecting, at a computer, a communication associated with an online entity;
obtaining, at the computer, a trust score associated with the online entity;
based on the trust score, determining an appriate action to take with respect to the communication; and
taking the appropriate action.

2. The method of claim 1, wherein obtaining the trust score comprises determining if a local trust cache includes the trust score.

3. The method of claim 2, wherein obtaining the trust score further comprises retrieving the trust score from the local trust cache.

4. The method of claim 2, wherein the local trust cache does not include the trust score, and wherein obtaining the trust score further comprising transmitting, from the computer, a request for the trust score to a trust score server.

5. The method of claim 4, wherein the trust score server is selected from a group consisting of an authoritative server, a root server and a trust evaluation system.

6. The method of claim 4, further comprising:
retrieving, at the trust score server, the trust score from a server cache associated with the trust score server; and
transmitting the trust score to the computer.

7. The method of claim 4, further comprising:
determining, at the trust score server, that a server cache associated with the trust score server does not include the trust score;
transmitting a request for the trust score to a second trust score server at a higher hierarchical level that the trust score server; and
receiving the trust score from the second trust score server.

8. The method of claim 7, further comprising storing the trust score in the server cache.

9. The method of claim 7, further comprising:
receiving, at a trust evaluation system configured to evaluate online entities, a request for the trust score;
retrieving, at the trust evaluation system, the trust score from a trust data store; and
transmitting the trust score to a lower hierarchy trust score server.

10. The method of claim 1, wherein detecting the communication comprises detecting a request for data from the online entity.

11. The method of claim 1, wherein detecting the communication comprises detecting a communication received from the online entity.

12. The method of claim 1, wherein obtaining the trust score comprises obtaining the trust score from a domain name system (DNS) record associated with the online entity.

13. The method of claim 1, wherein the computer is a border device.

14. The method of claim 1, wherein the computer is a client computer executing a client application.

15. The method of claim 14, wherein the client application detects the communication.

16. The method of claim 14, wherein the client application is a first application and wherein a second application detects the communication.

17. The method of claim 14, wherein the client application is selected from the group consisting of an email client, a web browser, and an instant messaging client.

18. A method of distributing trust scores from a trust evaluation system, the method comprising:
determining, at the trust evaluation system, a trust score for each of a plurality of online entities;
populating, with the trust evaluation system, a trust database with the trust scores; and
transmitting, from the trust evaluation system, at least a portion of the data included in the trust database to a cache server.

19. The method of claim 18, further comprising transmitting at least a second portion of the data included in the trust database to one or more additional cache servers.

20. The method of claim 18, wherein the cache server is a root server.

21. A method of distributing trust scores from a trust evaluation system evaluating online entities, the method comprising:
retrieving a first plurality of trust scores from a trust data store, the first plurality of trust scores associated with a first set of online entities, each of the first plurality of trust scores evaluating an online entity included in the first set;
retrieving a second plurality of trust scores from the trust data store, the second plurality of trust scores associated with a second set of online entities, each of the second plurality of trust scores evaluating an online entity included in the second set;
transmitting, from the trust evaluation system, the first plurality of trust scores to a first trust score server; and
transmitting, from the trust evaluation system, the second plurality of trust scores to a second trust score server.

22. The method of claim 21, wherein the first set of online entities corresponds to a first online region and wherein the second set of online entities corresponds to a second online region.

23. The method of claim 22, wherein the first online region comprises a first top level domain and wherein the second online region comprises a second top level domain.

24. The method of claim 22, wherein the first online region comprises a first geographical region and wherein the second online region comprises a second geographical region.

25. A method of distributing trust scores for online entities, the method comprising:
maintaining, at a domain name system (DNS) server, a DNS record comprising a set of information about an online entity, the set of information comprising one or more trust scores associated with the online entity;
upon receiving a request, providing at least some of the set of information about the online entity.

26. The method of claim 25, wherein the request is a DNS lookup request.

27. The method of claim 25, wherein the request is a request for at least one of the one or more trust scores.

28. The method of claim 25, wherein the at least some of the information about the online entity includes at least one of the one or more trust scores.

29. A trust authentication system comprising:
a client application configured to communicate with online entities; and
a monitoring agent communicatively coupled with the client application and configured to obtain trust scores for the online entities.

30. The trust authentication system of claim 29, further comprising a local trust cache configured to cache a plurality of the trust scores.

31. The trust authentication system of claim 30, wherein the monitoring agent is configured to request from a trust score server trust scores not included in the local trust cache.

32. The trust authentication system of claim 29, further comprising a trust evaluation system configured to create the trust scores for the online entities.

33. The trust authentication system of claim 30, wherein the location trust cache is a domain name system (DNS) cache.

34. A method of providing trust scores, the method comprising:
providing a database comprising one or more trust scores for each of a plurality of online entities, wherein each of the trust scores indicates an evaluation of the trustworthiness of an online entity to which the trust score relates;
receiving at a computer a request for at least one of the one or more trust scores of one of the plurality of entities; and
providing with the computer, in response to the request, the at least one of the one or more trust scores.

35. A system for providing trust scores, the system comprising:
at least one database comprising one or more trust scores for each of a plurality of online entities, wherein each of the trust scores indicates an evaluation of the trustworthiness of an online entity to which the trust score relates; and
at least one trust server in communication with the at least one database, the trust server comprising a processor and instructions executable by the processor to:
receive a request for at least one of the one or more trust scores for one of the plurality of entities; and
provide, in response to the request, the at least one of the one or more trust scores.

36. The system of claim 35, wherein:
the at least one database is a plurality of databases; and
the at least one trust server is a plurality of trust servers, each of the plurality of trust servers being in communication with one or more of the plurality of databases.

37. The system of claim 36, wherein:
the plurality of databases comprises a first database having a first subset of a set of trust scores and a second database having a second subset of the set of trust scores;
the plurality of trust servers comprises a first trust server in communication with the first database and a second trust server in communication with the second database;
the first trust server is designated an authoritative server with respect to the first subset of the set of trust scores; and
the second trust server is designated an authoritative server with respect to the second subset of the set of trust scores.

38. The system of claim 37, further comprising:
at least one root server comprising a processor and instructions executable by the processor to:
receive a request for a trust score;
determine whether the requested trust score falls within the first subset of the set trust scores or the second subset of trust scores; and
provide a reference to either the first trust server or the second trust server, depending on which subset of the set of trust scores the requested score falls within.

39. The system of claim 37, wherein:
the first subset of the set of trust scores comprises trust scores for a first plurality of online entities; and
the second subset of the set of trust scores comprises trust scores for a second plurality of online entities.

40. The system of claim 39, wherein:
the first plurality of online entities are located in a first region; and
the second plurality of online entities are located in a first region.

41. The system of claim 39, wherein:
the first plurality of online entities are associated with domains in a first top level domain; and
the second plurality of online entities are associated with domains in a second top level domain.

42. The system of claim 37, wherein:
the first subset of the set of trust scores comprises trust scores related to a first category of activity; and
the second subset of the set of trust scores comprises trust scores related to a second category of activity.

43. The system of claim 37, wherein:
the first subset of the set of trust scores comprises trust scores scaled according to a first scale; and
the second subset of the set of trust scores comprises trust scores scaled according to a second scale.

44. The system of claim 43, wherein at least one of the first and second scales comprises a blacklist.

45. A software program embodied on at least one computer readable medium, the software comprising instructions executable by one or more computers to:
detect a communication associated with an online entity; and
obtain a trust score associated with the online entity.

46. A software program embodied on at least one computer readable medium, the software comprising instructions executable by one or more computers to:
maintain a database comprising one or more trust scores for each of a plurality of online entities, wherein each of the trust scores indicates an evaluation of the trustworthiness of an online entity to which the trust score relates;
receive a request for at least one of the one or more trust scores of one of the plurality of entities; and
provide, in response to the request, the at least one of the one or more trust scores.

47. A system, comprising:
a data store comprising one or more trust scores for each of a plurality of online entities, wherein each of the trust scores indicates an evaluation of the trustworthiness of an online entity to which the trust score relates;
means for receiving at a computer a request for at least one of the one or more trust scores of one of the plurality of entities; and
means for providing with the computer, in response to the request, the at least one of the one or more trust scores.

48. A system for providing trust information about online entities, the system comprising:
at least one authoritative database comprising a set scoring information about a plurality of online entities; and
at least one cache database comprising at least a subset of the set of information about the plurality of online entities; and
a trust server in communication with the cache database, the trust server being configured to:
receive a request for scoring information about a particular entity;
determine whether the cache database comprises scoring information about the particular entity;
determine whether the cache database's scoring information about the particular entity has expired;
provide in response to the request any unexpired scoring information about the particular entity; and
if no unexpired scoring information about the particular entity exists, forward the request to the authoritative server.

49. A system as recited in claim 48, wherein the cache server is configured to obtain from the authoritative database the subset of the set of information about the plurality of online entities.
